(19) United States
(12) Patent Application Publication
(10) Pub. No.: US 2026/0266761 A1
(43) Pub. Date: Sep. 10, 2026

(54) Modular Radiant Light Generation in Analysis System

(71) Applicant: DH Technologies Development Pte. Ltd., Singapore (SG)

(72) Inventor: Brian D. PETERSON, Brea, CA (US)

(21) Appl. No.: 19/162,524

(22) PCT Filed: Mar. 7, 2024
(86) PCT No.: PCT/IB2024/052226

§ 371 Date: Sep. 5, 2025

Related U.S. Application Data
(60) Provisional application No. 63/489,368, filed on Mar. 9, 2023.

(51) Int. Cl. G01N 27/447; G02B 6/36

(52) U.S. Cl. CPC G01N 27/44721; G01N 27/44791; G02B 6/3624

(57) ABSTRACT

Examples of the disclosure relate to a modular radiant light generation apparatus, including a modular receiver including a recessed portion, a radiant light source on a bottom surface of the recessed portion of the modular receiver, a first fitting on the radiant light source, a fiber optic jacket including a fiber optic core therein, a first portion of the fiber optic jacket coupled to the second fitting being inserted in the first fitting, and a third fitting including a threaded projection and a biasing element the second fitting being coupled to the first fitting being configured to align the fiber optic core with the radiant light source, and the biasing element being configured to keep the fiber optic core in contact with the radiant light source.

### CROSS-REFERENCE TO RELATED APPLICATIONS

This application claims priority to, and the benefit of, U.S. Provisional Application No. 63/489,368, entitled “MODULAR RADIANT LIGHT GENERATION IN ANALYSIS SYSTEM,” and filed Mar. 9, 2023, the content of which is incorporated herein by reference in its entirety.

### BACKGROUND

Current analytical methods and systems (e.g., capillary electrophoresis (CE) methods and system) may use an ultra-violet (UV) light sources (e.g., UV light emitting, diode (LED)) as part of a detection set-up. Such light sources have limited lifetime and thus require replacement. But such light sources might not be easily accessible to a user and might require extensive fiber coupling and alignment and other time-consuming manipulations when replacement is performed. Thus, there is a need for an easily assessable and replaceable light source set-up.

### SUMMARY

In one aspect, the technology relates to a modular radiant light generation apparatus that includes a modular receiver including a recessed portion, a radiant light source on a bottom surface of the recessed portion of the modular receiver, a first fitting on the radiant light source, a fiber optic core in contact with the radiant light source, a second fitting encasing a portion of the fiber optic core therein, a portion of the second fitting being inserted in the first fitting, a fiber optic jacket encasing another portion of the fiber optic core therein, a sleeve encasing the fiber optic jacket and the second fitting, the sleeve being adhered to outside surfaces of the fiber optic jacket and of the second fitting, and a third fitting encasing a biasing element and a portion of the sleeve, the biasing element being configured to keep the fiber optic core in contact with the radiant light source.

In an example of the above aspect, the first fitting is configured to align the fiber optic core with the radiant light source. In another example, the apparatus further includes a retaining clip on the second fitting, the retaining clip being configured to maintain the biasing element in a compressed configuration. In yet another example, the third fitting includes a threaded projection on an outside surface thereof.

In another example of the above aspect, the radiant light source includes a UV light source. In an example, the apparatus further includes a substrate between the bottom surface of the recessed portion and the UV light source. In a further example, a material of at least one of the substrate, the UV light source and the modular receiver includes aluminum. In yet another example, the first fitting is configured to automatically align a central portion of the fiber optic core with a central portion of the UV light source. For example, the UV light source includes a UV LED. In another example, the first fitting and the fiber optic core are concentric. In other example, the biasing element is configured to apply a pressure on the fiber optic core in a longitudinal direction thereto towards the radiant light source. In other examples, the biasing element includes a spring. In further examples, the apparatus further includes an electric port configured to be coupled to an external circuitry.

In another aspect, the technology relates to a capillary electrophoresis system, including a capillary electrophoresis apparatus, an accessible port at the capillary electrophoresis apparatus, the accessible port being configured to receive the modular receiver discussed above, a removable instrument dock coupled to the accessible port, a plurality of joining mechanisms configured to join the modular receiver to the removable instrument dock, and a removable bracket in thermal contact with the instrument dock and an inside wall of the capillary electrophoresis apparatus.

In an example of the above aspect, the plurality of joining mechanisms include a plurality of threaded screws, the threaded screws being configured to threadably engage at least one of the modular receiver and the instrument dock. In a further example, a material of at least one of the substrate, the UV light source, the modular receiver, the instrument dock, and the removable bracket includes aluminum. In another example, the UV light source has a wavelength in a range of 200-405 nm with a full-width at half-maximum in a range of 9-30 nm. In yet another example, the accessible port is further configured to receive a UV lamp.

### BRIEF DESCRIPTION OF THE DRAWINGS

FIG. 1 is schematic description of a multi-mode capillary electrophoresis system.

FIG. 2 is a cross-section of a modular radiant light generation apparatus, in accordance with various examples of the disclosure.

FIGS. 3A-3C are cross-section views and perspective views of a modular radiant light generation apparatus, in accordance with various examples of the disclosure.

FIG. 4 is a cross-section of a modular radiant light generation apparatus, in accordance with various examples of the disclosure.

FIG. 5 is a portion of a perspective view of a modular radiant light generation apparatus, in accordance with various examples of the disclosure.

FIG. 6 is a perspective view of a modular radiant light generation apparatus, in accordance with various examples of the disclosure.

FIGS. 7A-7C depict examples of a modular radiant light generation apparatus coupled to a capillary electrophoresis apparatus, in accordance with various examples of the disclosure.

FIG. 8 illustrates a UV LED in a modular radiant light generation apparatus, in accordance with various examples of the disclosure.

### DETAILED DESCRIPTION

Using an LED as a source of UV radiation in an analytical instrument, due to the typically limited lifetime of the LED (relative to the lifetime of the instrument), requires replacement of the LED at defined intervals. When LED UV sources are mounted inside of an instrument (e.g., a CE instrument), the replacement of the source might necessitate an extensive alignment and other manipulations, might be a time-consuming task, and might require trained service personnel to perform the replacement operations. Examples of this disclosure provide a user-accessible interface to remove and install an LED UV source without requiring repeated steps of optical fiber coupling and alignment. For example, the LED UV source is a module containing a commercial UV LED mounted in a housing configured to mate with a dock mounted inside an instrument, but that is directly accessible from the outside, e.g., behind an access door.

Advantages of examples described in this disclosure include an apparatus and a system with a light source that is substantially easier to replace by an untrained user, which allows the user to return the instrument to full functionality in a short amount of time. When the LED UV light source output drops below an acceptable level, the user can easily replace it without undergoing the expense and delay of a maintenance service call which is typically required when replacing a UV light source. Such a configuration, or similar configurations, allows a user themselves to change UV LED source, which is substantially more convenient and saves the cost of scheduling and performing a maintenance visit.

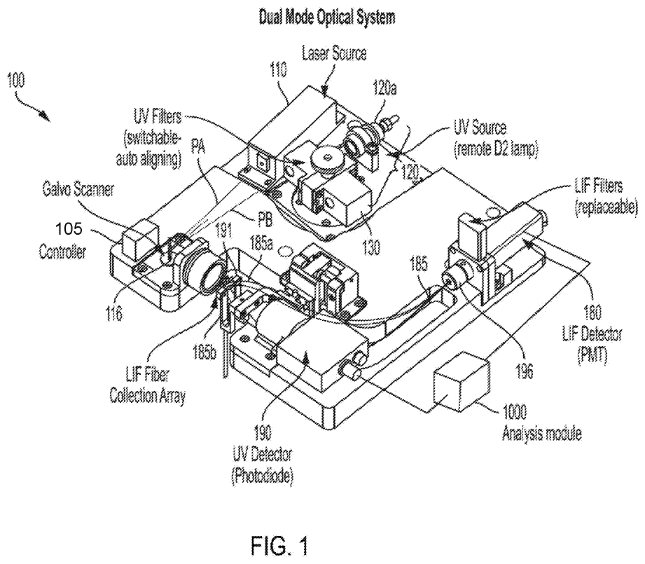

FIG. 1 is schematic description of a multi-mode capillary electrophoresis system. The multi-mode capillary electrophoresis system 100 includes a UV radiation source 120a, UV filters 130, and a laser source 110. The UV radiation source 120a can be, for example, a broad-spectrum UV lamp 120a which can generate UV radiation, and the laser source 110 can be any suitable laser, which generates laser radiation for eliciting fluorescent radiation from one or more samples. By way of example, the laser source 110 can generate radiation with one or more wavelengths in a range of about 372 nm to about 980 nm, for performing laser-induced fluorescence study of those samples. A plurality of switchable UV filters 130 are provided, which can be selected one at a time for filtering the radiation generated by the UV radiation apparatus 120. The multi-mode capillary electrophoresis system 100 further includes suitable optics for directing the radiation emitted (or absorbed) by a sample being analyzed. In an embodiment, a galvanometric scanning mirror 116 can receive radiation emitted by the UV radiation apparatus 120 and the laser 110 along different paths (PA) and (PB), respectively, and direct the UV radiation and the laser light onto a common optical path. A UV detector 190 (e.g., a photodiode detector) is positioned substantially along the common optical path along which the galvanometric mirror 116 directs the UV radiation and the laser light. The photodiode detector 190 may also serve to initially align the beam positions to the center of each window.

The system 100 further includes a fluorescence detector 180 for detecting the laser-induced or UV-induced fluorescence, which is a photomultiplier tube (PMT) in this implementation, for detecting the fluorescent radiation emitted by the samples. As discussed in more detail below, in this embodiment, the fluorescence detector receives the emitted fluorescent radiation via a plurality of optical fibers 185 attached to a plate 191. An array of optical fibers 185a is positioned above the plane of the optical axis of the radiation (i.e., the common optical path) and the fibers are angled downward at about 45 degrees so as to receive at least a portion of the fluorescent radiation emitted by the samples. Another array of optical fibers 185b is positioned below the plane of the optical axis and the fibers of that array are angled upward at about 45 degrees to receive at least a portion of the fluorescent radiation emitted by the samples. The distal ends of the optical fibers 185 are coupled to a fiber coupling element 196 that aligns the distal ends of the optical fibers with the fluorescence detector. A controller 105 can control the scanning of the galvanometric mirror 116 to direct the UV radiation or the laser light beam. The controller 105 can be implemented in hardware, firmware and/or software. The fluorescent radiation emitted by the sample is collected by the fibers 185, which then transmit the collected fluorescent radiation to the fluorescence detector 180. The system 100 may also include analysis module 1000 in communication with the photodiode detector 190 and the fluorescence detector 180 to receive the detection signals from these detectors and operate on the signals to obtain information regarding the samples.

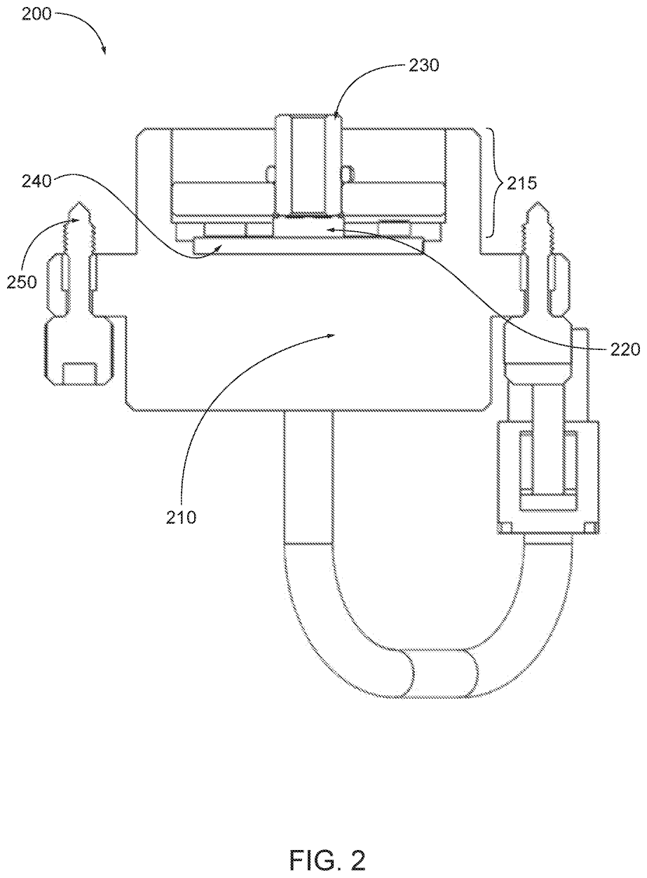

FIG. 2 is a cross-section of a modular radiant light generation apparatus 200, in accordance with various examples of the disclosure. In FIG. 2, the modular apparatus 200 includes modular receiver 210 that has a recessed portion 215 therein. The modular receiver 210 may be made of, or include, a thermally conductive material such as, e.g., aluminum, or other thermally conductive rigid material. The modular apparatus 200 may also include a radiant light source 220 such as, e.g., a UV light source 220, on a bottom surface of the recessed portion 215. The modular apparatus 200 may be made of or include a rigid thermally conductive material such as, e.g., aluminum. The radiant light source 220 may also be made of, or include, a rigid thermally conductive material such as, e.g., aluminum. For example, the UV light source 220 may be or include a UV LED 220. The UV LED 220 may have a wavelength in a range of 200-405 nm with a full-width at half-maximum in a range of 9-30 nm. The modular apparatus 200 may also include a first fitting 230 disposed on the radiant light source 220, the first fitting 230 being, e.g., a semi-precision coaxial connector or a subminiature version A (SMA) connector 230. The modular apparatus 200 may further include a substrate 240 between the bottom surface of the recessed portion 215 and the radiant light source 220 within the recessed portion 215. The substrate 240 may be made of or include a rigid thermally conductive material such as, e.g., aluminum. In an example, the modular apparatus 200 may be configured to be attached or joined to another structure such as, e.g., a capillary electrophoresis system, via one or more joining mechanisms 250 which may be, e.g., threaded screws 250.

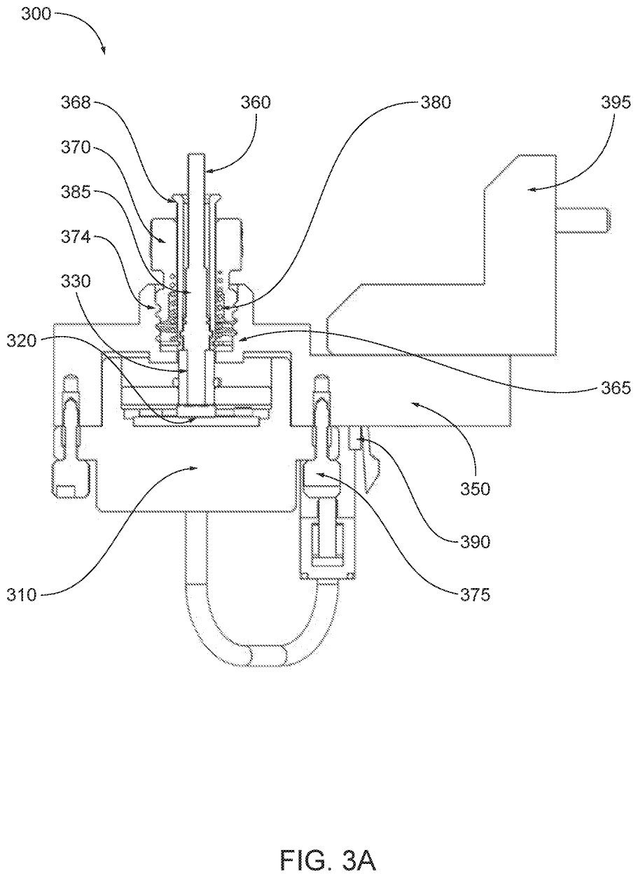

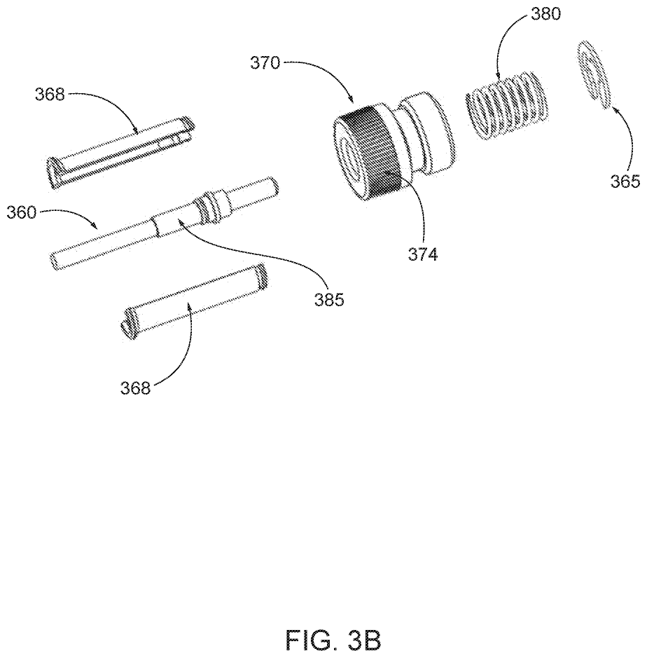

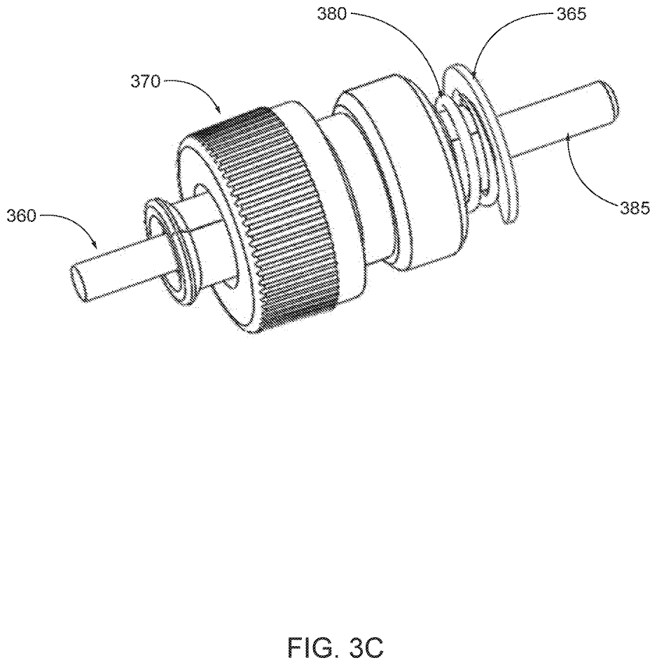

FIGS. 3A-3C are cross-section and perspective views of a modular radiant light generation apparatus, in accordance with various examples of the disclosure. In FIG. 3A, the modular apparatus 300, which includes the modular receiver 310, includes a fiber optic jacket 360 encasing, e.g., a portion of a fiber optic core. The fiber optic jacket 360 is coupled to a fitting 385, also referred as second fitting 385, the second fitting 385 also encasing a portion of the fiber optic core. A portion of the second fitting 385 is inserted in the first fitting 330. In an example, the fiber optic jacket 360 and the second fitting 385 are enclosed in a sleeve 368. The sleeve 368 may be adhered to an outside surface of the fiber optic jacket 360 and the second fitting 385 via an adhesive such as, e.g., glue.

In examples, the first fitting 330 is configured to align, or to automatically align, the fiber optic cable or cable core encased inside the second fitting 385 and the fiber optic jacket 360 with the radiant light source 320. The first fitting 330 may be configured to align, or automatically align, a central portion of the fiber optic core inside the second fitting 385 and the fiber optic jacket 360 with a central portion of the radiant light source 320. The modular apparatus 300 may also include a third fitting 370, the third fitting 370 having a biasing element 380 encased therein. In various examples, the third fitting 370 is coupled to the sleeve 368 by, e.g., enclosing or encasing at least a portion of the sleeve 368. The biasing element 380 may be, e.g., a spring or an elastomeric or elastic element configured to exert a biasing force to keep the fiber optic cable or cable core located inside the fiber optic jacket 360 in contact with the upper surface of the radiant light source 320, for example, by biasing the fiber optic cable in a longitudinal direction towards the radiant light source 320. A retainer clip 365 may be added to the second fitting 385 so as to maintain the spring 380 in a coiled configuration so as to maintain the pressure on the fiber optic cable to remain in contact with the upper surface of the radiant light source 320. The modular apparatus 300 further includes an electrical fitting or port 390 configured to couple the modular apparatus 300 to, e.g., an external circuitry.

In various examples, the modular apparatus 300 may be coupled to a removable instrument dock 350, the instrument dock 350 being affixed to an apparatus such as e.g., a CE apparatus (not shown), and being configured to couple the modular apparatus 300 to the CE apparatus. The instrument dock 350 may be made of or include a rigid thermally conductive material such as, e.g., aluminum. When the apparatus is coupled to a CE apparatus, then the instrument dock 350 is configured to couple the modular apparatus 300 to the CE apparatus. For example, the third fitting 370 includes threaded projections 374 on an outside surface thereof, and the instrument dock 350 includes threaded recesses configured to engage with the threaded projections 374 of the third fitting 370. The modular apparatus 300 may be affixed to an inside wall of the apparatus such as, e.g., an inside wall of the CE apparatus, via a bracket 395. The bracket 395 may be a removable bracket and may be configured to transfer heat from the instrument dock 350, or from the modular receiver 310 via the instrument dock 350, to an outside of the apparatus 300, e.g., out of the CE apparatus to which the modular apparatus 300 is coupled. The bracket 395, which may be removable, may be made of or include a rigid thermally conductive material such as, e.g., aluminum. The modular apparatus 300 may be attached or joined to the CE apparatus via one or more joining mechanisms 375 which may be, e.g., threaded screws 375 that join the modular receiver 310 to the instrument dock 350. For example, the threaded screws threadably engage at least one of the modular receiver and the instrument dock.

In FIGS. 3B and 3C, a portion of the modular apparatus 300 is illustrated, the illustrated portion including the fiber optic jacket 360 encasing, e.g., a fiber optic core (not shown) therein, the fiber optic jacket 360 being coupled or appended to a second fitting 385 which also encases another portion of the fiber optic core therein. Alternatively, element 360 may also represent the fiber optic core that is encased in the fiber optic jacket. The exploded view of FIG. 3B shows that the fiber optic jacket 360 and the second fitting 385 are encased in a sleeve 368 that may be, e.g., adhered or glued to the outer surfaces of the fiber optic jacket 360 and of the second fitting 385. In examples, the sleeve 368, which encases the fiber optic jacket 360 and the second fitting 385, is fitted inside the third fitting 370, and the third fitting 370 also encompasses the biasing element 380 such, e.g., a spring. Accordingly, a pressure may be exerted by the biasing element 380 on, e.g., the radiant light source 320 illustrated in FIG. 3A. The retainer clip 365 is configured to maintain the spring 380 in a coiled configuration. This, for example, can then maintain the pressure on the second fitting 385. This also, for example, can help the fiber optic core (not shown) to remain in contact with the upper surface of the radiant light source 320. For example, the third fitting 370 has a threaded projection 374 configured to threadably engage to another structure. With reference to FIG. 3A, the threaded projection 374 is threadably engaged with a threaded recess of the instrument dock 350. FIG. 3C illustrates the portion of the modular apparatus 300 in an assembled configuration.

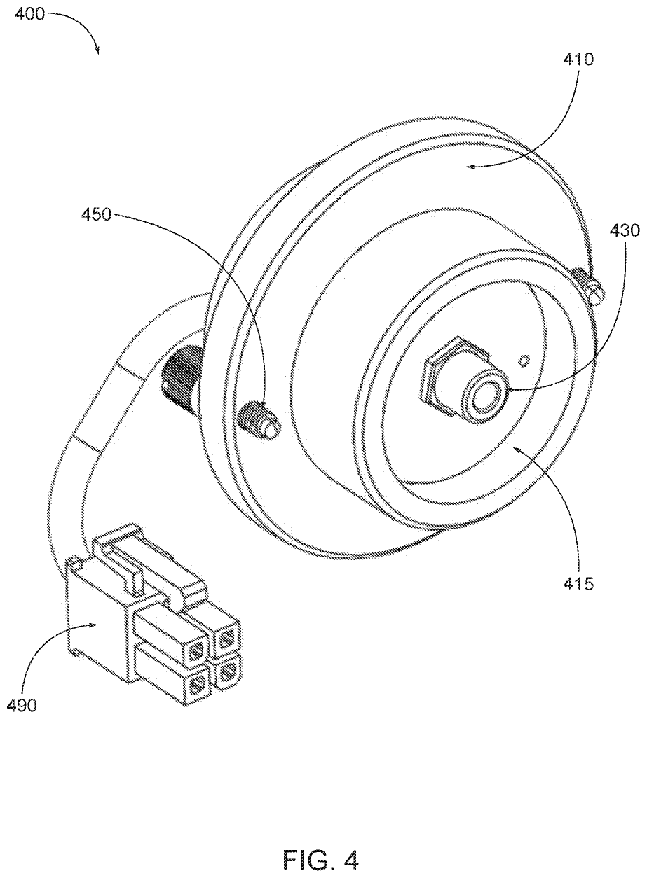

FIG. 4 is a perspective view of a modular radiant light generation apparatus, in accordance with various examples of the disclosure. In FIG. 4, the modular apparatus 400 includes modular receiver 410 with a recessed portion 415 therein, and a first fitting 430, e.g., located on a radiant light source (not shown). The modular apparatus 400 may be configured to be attached or joined to another structure such as, e.g., a CE apparatus, via one or more joining mechanisms 450 which may be, e.g., threaded screws 450. The modular apparatus 400 may further include an electrical fitting or port 490 configured to couple the modular apparatus 400 to, e.g., an external circuitry.

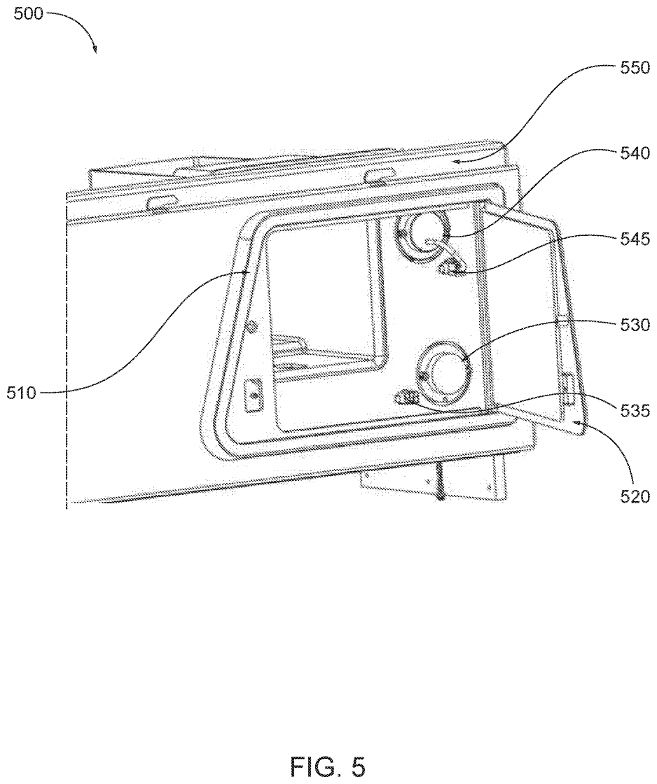

FIG. 5 depicts a portion of a CE system 500, in accordance with various examples of the disclosure. In FIG. 5, the CE system 500 includes a CE apparatus (not shown) such as, e.g., the CE apparatus 100 discussed above with respect to FIG. 1, an opening 510 at, e.g., a side wall 550 of the CE system 500, the opening 510 having an accessible port or door 520 configured to provide access to the opening 510. The CE system 500 may include, in the opening 510, a first radiant light source 530, and a second radiant light source 540 functionally coupled to the CE system 500 via the electrical fitting or port 545. The first radiant light source 530 may be or include a first UV radiant light source such as, e.g., a UV lamp. With reference to FIG. 1 discussed above, the first radiant light source 530 may be similar to the UV radiation source 120a and may also be coupled to the CE system 500 via the electrical fitting or port 535. The UV radiant source 530 may be or include a Deuterium lamp 530, and may be a removable Deuterium lamp 530. The second radiant light source 540 may be or include, e.g., a second UV radiant light source 540. The second UV radiant light source 540 may be or include a UV LED 540, and the UV LED 540 may be removable. With reference to FIG. 3 discussed above, the second radiant light source 540 may correspond to the modular apparatus 300.

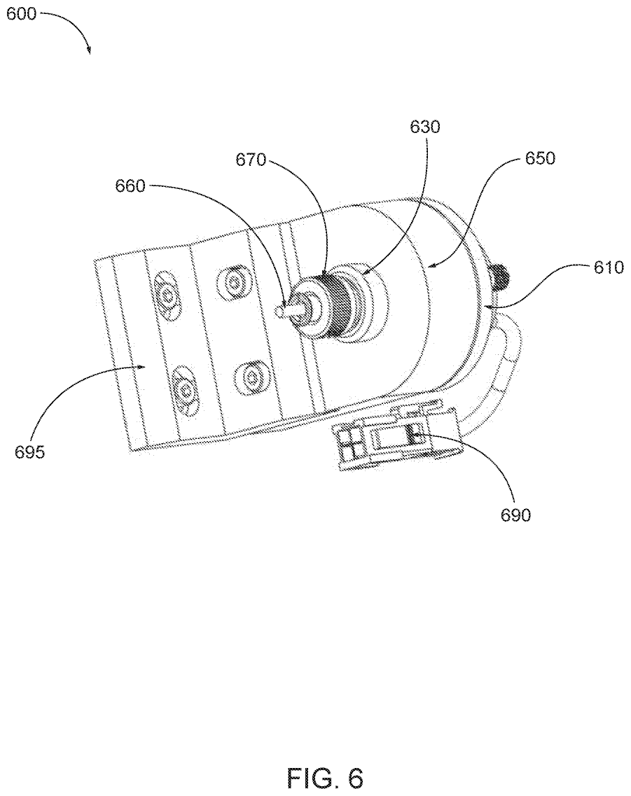

FIG. 6 is a perspective view of a modular radiant light generation apparatus 600 affixed to a bracket 695 for securing the apparatus 600 to a device (not shown, but such as a CE system). In FIG. 6, the removable instrument dock 650 is affixed to the bracket 695, which is secured to an apparatus such as a CE system (not shown). This configuration enables coupling of the modular receiver 610 to the CE system. The modular apparatus 600, which includes the modular receiver 610, may also include fiber optic jacket 660 having, e.g., a fiber optic core (not shown) therein. A first portion of the fiber optic jacket 660 may be inserted in the first fitting 630. The modular apparatus 600 may include a third fitting 670. The bracket 695 may be a removable bracket and may be configured to transfer heat from the instrument dock 650, or from the modular receiver 610 via the instrument dock 650, out of the apparatus 600 and, e.g., out of the CE system. The bracket 695, which may be removable, may be made of or include aluminum or other thermally-conductive metal or conductive plastic. The modular apparatus 600 may further include an electric port 690 configured to couple the modular apparatus 600 to, e.g., an external circuitry.

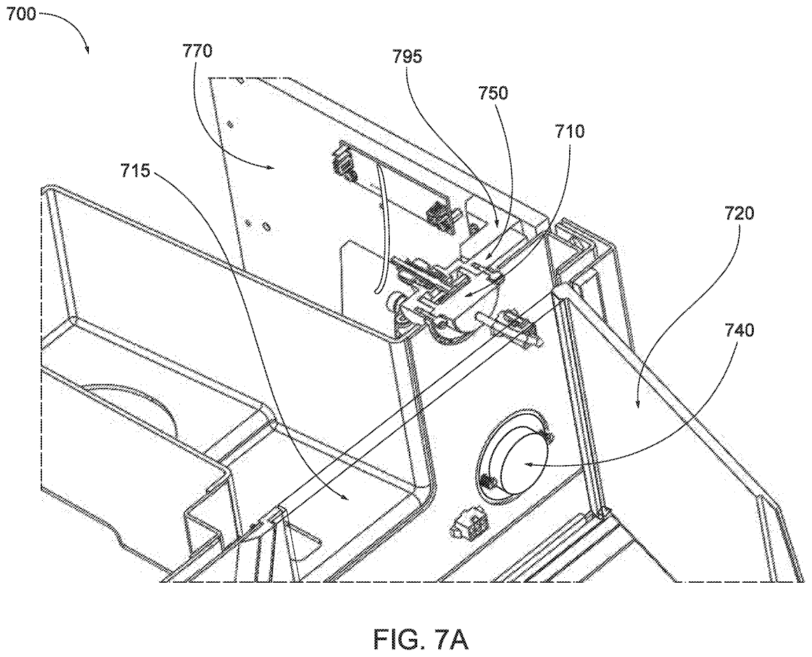

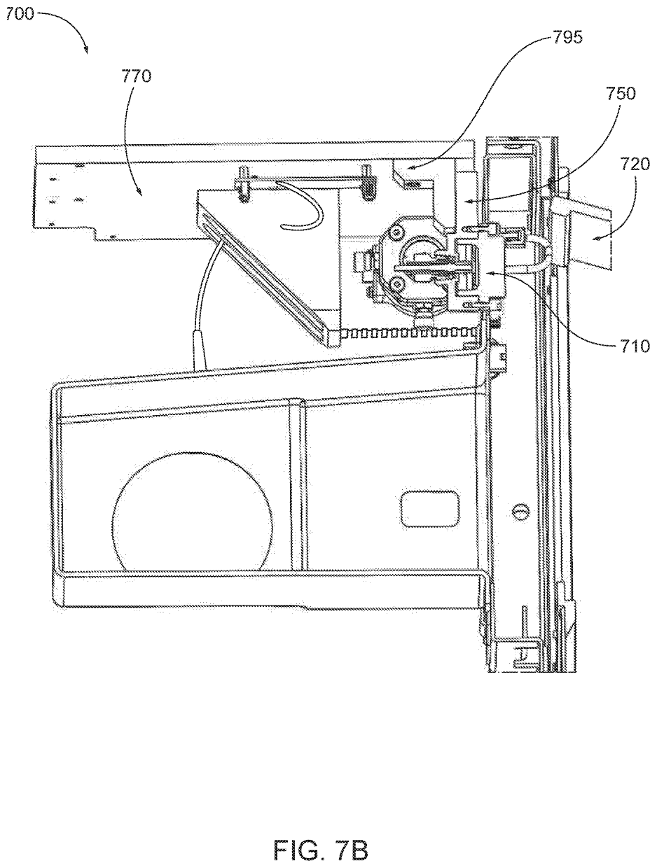

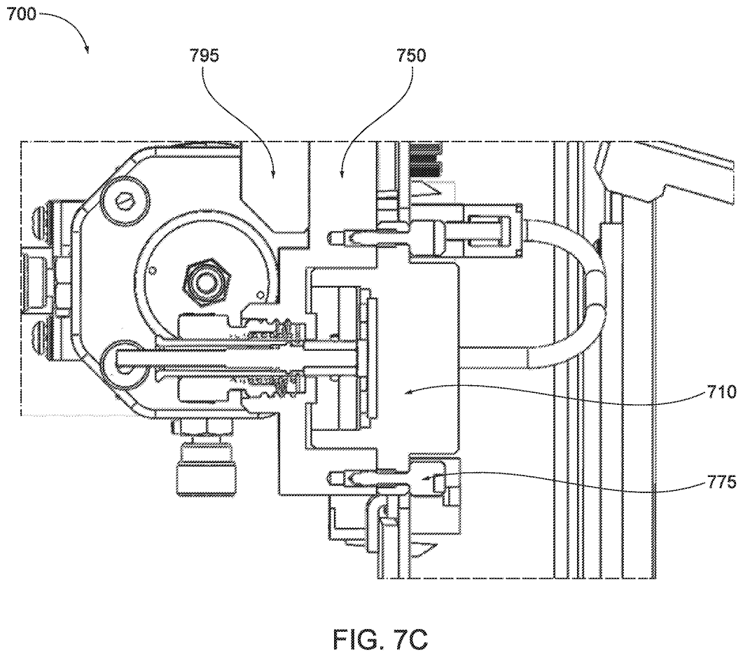

FIGS. 7A-7C illustrate examples of a modular radiant light generation apparatus 710 coupled to a CE system 700, in accordance with various examples of the disclosure. FIGS. 7A-7C are described concurrently and not every component described is depicted in every figure. With reference to FIGS. 7A-7C, the CE system 700 includes a modular radiant light generation device 710 coupled thereto via, e.g., instrument dock 750, and the instrument dock 750 is affixed to an interior wall 770 of the CE system 700 via a removable bracket 795. The bracket 795 may be configured to transfer heat from the instrument dock 750, or from the modular radiant light generation device 710 via the instrument dock 750, out of the CE system 700. The CE system 700 includes an opening 715 having a door 720 configured to provide access thereto. The CE system 700 also includes a radiant light source 740 which may be or include, e.g., a UV LED 740, and the UV LED 740 may be removable. The modular radiant light generation apparatus 710 may be attached or joined to the CE system via one or more joining mechanisms 775 which may be, e.g., threaded screws 775 that join the modular radiant light generation device 710 to the instrument dock 750 via a threaded engagement.

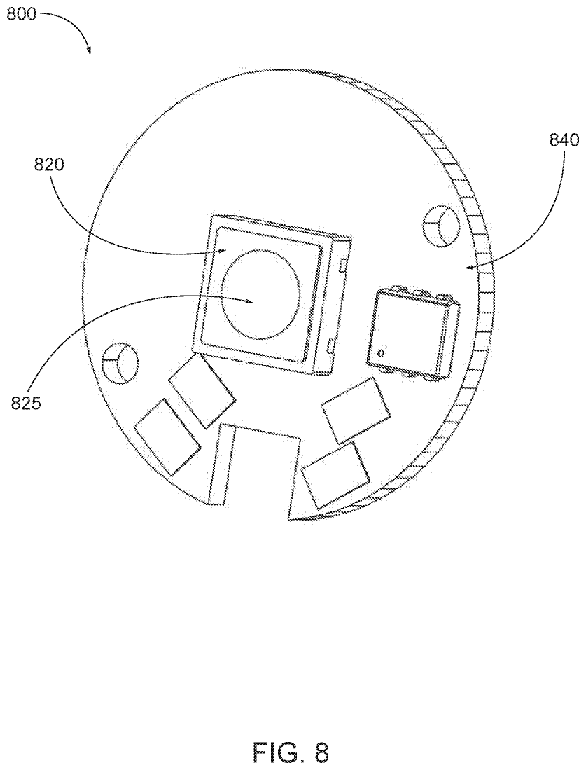

FIG. 8 illustrates a UV LED in a modular radiant light generation apparatus, in accordance with various examples of the disclosure. In FIG. 8, the modular radiant light generation apparatus 800 includes a UV light source 820 such as, e.g., a UV LED 820 disposed on a substrate 840. The UV LED 820 and the substrate 840 may be placed in the recess of a modular receiver such as, e.g., in the recess 215 of the modular receiver 210 illustrated in FIG. 2 discussed above. A central portion 825 of the UV LED 820 may be aligned and concentric to a fiber optic (not shown) that is in contact with the surface of the UV LED 820 when placed in a modular receiver.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples.

Examples according to the technology may also combine elements or components of those that are disclosed in general but not expressly exemplified in combination, unless otherwise stated herein. The scope of the technology is defined by the following claims and any equivalents therein.

1. A modular radiant light generation apparatus, comprising:
a modular receiver comprising a recessed portion;
a radiant light source on a bottom surface of the recessed portion of the modular receiver;
a first fitting on the radiant light source;
a fiber optic core in contact with the radiant light source;
a second fitting encasing a portion of the fiber optic core therein, a portion of the second fitting being inserted in the first fitting;
a fiber optic jacket encasing another portion of the fiber optic core therein;
a sleeve encasing the fiber optic jacket and the second fitting, the sleeve being adhered to outside surfaces of the fiber optic jacket and of the second fitting; and
a third fitting encasing a biasing element and a portion of the sleeve, the biasing element being configured to keep the fiber optic core in contact with the radiant light source.

2. The apparatus of claim 1, wherein the first fitting is configured to align the fiber optic core with the radiant light source.

3. The apparatus of claim 1, further comprising a retaining clip on the second fitting, the retaining clip being configured to maintain the biasing element in a compressed configuration.

4. The apparatus of claim 1, wherein the third fitting comprises a threaded projection on an outside surface thereof.

5. The apparatus of claim 1, wherein the radiant light source comprises a UV light source.

6. The apparatus of claim 5, further comprising a substrate between the bottom surface of the recessed portion and the UV light source.

7. The apparatus of claim 6, wherein a material of at least one of the substrate, the UV light source and the modular receiver comprises aluminum.

8. The apparatus of claim 5, wherein the first fitting is configured to automatically align a central portion of the fiber optic core with a central portion of the UV light source.

9. The apparatus of claim 5, wherein the UV light source comprises a UV LED.

10. The apparatus of claim 1, wherein the first fitting and the fiber optic core are concentric.

11. The apparatus of claim 1, wherein the biasing element is configured to apply a pressure on the fiber optic core in a longitudinal direction thereto towards the radiant light source.

12. The apparatus of claim 1, wherein the biasing element comprises a spring.

13. The apparatus of claim 1, further comprising an electrical port configured to be coupled to an external circuitry.

14. A capillary electrophoresis system, comprising:
a capillary electrophoresis apparatus;
an accessible port at the capillary electrophoresis apparatus, the accessible port being configured to receive the modular receiver of the modular radiant light generation apparatus of claim 1;
a removable instrument dock coupled to the accessible port;
a plurality of joining mechanisms configured to join the modular receiver to the removable instrument dock; and
a removable bracket in thermal contact with the instrument dock and an interior wall of the capillary electrophoresis apparatus.

15. The system of claim 14, wherein the plurality of joining mechanisms comprise a plurality of threaded screws, the threaded screws being configured to threadably engage at least one of the modular receiver and the instrument dock.

16. The system of claim 14, wherein a material of at least one of the substrate, the UV light source, the modular receiver, the instrument dock, and the removable bracket comprises aluminum.

17. The system of claim 14, wherein the UV light source has a wavelength in a range of 200-405 nm with a full-width at half-maximum in a range of 9-30 nm.

18. The system of claim 14, wherein the accessible port is further configured to receive a UV lamp.
